(19) United States
(12) Patent Application Publication
(10) Pub. No.: US 2018/0149175 A1
(43) Pub. Date: May 31, 2018

(54) Metering Fluid to a Fluid Actuator

(71) Applicant: Schlumberger Technology Corporation, Sugar Land, TX (US)

(72) Inventor: James Zapico, Houston, TX (US)

(21) Appl. No.: 15/364,662

(22) Filed: Nov. 30, 2016

(51) Int. Cl. F15B 13/04; E21B 19/14; F15B 11/08; G05B 15/02

(52) U.S. Cl. CPC F15B 13/0401; E21B 19/14; F15B 11/08; F15B 2211/6303; F15B 2211/30525; F15B 2211/7058; G05B 15/02

(57) ABSTRACT

Apparatus and methods for metering fluid to a fluid actuator. An example apparatus may include a hydraulic actuator and a fluid chamber. The fluid chamber may include a piston slidably movable between first and second ends of the fluid chamber and dividing the chamber into first and second chamber portions, a first port extending into the first chamber portion, and a second port extending into the second chamber portion. The apparatus may further include a hydraulic directional control valve operable to direct a fluid from a fluid source into one of the first and second ports to cause a volume of fluid to be discharged out of the other of the first and second ports into the hydraulic actuator to actuate the hydraulic actuator by a distance corresponding to the volume of fluid received by the hydraulic actuator.

### BACKGROUND OF THE DISCLOSURE

Wells are generally drilled into the ground or seabed to recover natural deposits of oil and gas, as well as other natural resources trapped in geological formations in the Earth's crust. Such wells are drilled using a drill bit attached to a lower end of a drill string or other drill piping. Drilling fluid (“mud”) is pumped from the wellsite surface down through the drill piping to the drill bit. The drilling fluid lubricates and cools the bit, and may additionally carry drill cuttings from the wellbore back to the surface from which the wellbore extends.

A typical drilling rig includes various lifting, rotating, and moving equipment, such as drill pipe moving and rotating devices utilized during drilling operations. Fluid actuators, such as hydraulic cylinders and rotary actuators, may power or actuate the moving equipment. Although fluid actuators may provide sufficient speeds and forces, precise movement and positioning of fluid actuators is difficult to achieve. Controlling fluid actuators to perform small or short movements may also be problematic, especially when utilizing large capacity fluid actuators. Inability to perform precise and/or small movements by the moving equipment may result in misalignment between drill pipes, downhole tools, and/or portions of the drilling rig, requiring manual adjustments to be performed and causing operational delays. Furthermore, precise control of fluid actuators typically require the use of position sensors in association with fluid actuators to monitor the position of the fluid actuators, increasing the cost and complexity of fluid control systems.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces an apparatus that includes a hydraulic actuator, a fluid chamber, and a hydraulic directional control valve. The fluid chamber contains a piston slidably movable between first and second ends of the fluid chamber and dividing the chamber into first and second chamber portions. The hydraulic directional control valve is operable to direct a fluid from a fluid source into the first chamber portion to cause a first volume of fluid to be discharged out of the second chamber portion into the hydraulic actuator to actuate the hydraulic actuator by a first distance corresponding to the first volume of fluid received by the hydraulic actuator. The hydraulic directional control valve is also operable to direct the fluid from the fluid source into the second chamber portion to cause a second volume of fluid to be discharged out of the first chamber portion into the hydraulic actuator to actuate the hydraulic actuator by a second distance corresponding to the second volume of fluid received by the hydraulic actuator.

The present disclosure also introduces an apparatus that includes a hydraulic actuator, a fluid chamber, and a hydraulic directional control valve. The fluid chamber contains a piston slidably movable between first and second ends of the fluid chamber. A first port extends into the fluid chamber on one side of the piston, and a second port extends into the fluid chamber on an opposing side of the piston. The hydraulic directional control valve includes a first port fluidly connected with a fluid source, a second port fluidly connected with the hydraulic actuator, a third port fluidly connected with the first port of the fluid chamber, and a fourth port fluidly connected with the second port of the fluid chamber. The hydraulic directional control valve is operable to direct a fluid from the fluid source into the first port of the fluid chamber until the piston reaches the first end to cause a volume of fluid to be discharged out of the second port of the fluid chamber. The hydraulic directional control valve is also operable to direct the discharged volume of fluid into the hydraulic actuator to actuate the hydraulic actuator by a distance corresponding to the volume of fluid received by the hydraulic actuator.

The present disclosure also introduces a method that includes directing a fluid from a fluid source into a first chamber portion of a fluid chamber until a piston dividing the fluid chamber into the first chamber portion and a second chamber portion moves from a first end of the fluid chamber to a second end of the fluid chamber, thus introducing a first volume of fluid into the first chamber portion and discharging a second volume of fluid from the second chamber portion. The second volume of fluid discharged from the second chamber portion is directed into a hydraulic actuator to actuate the hydraulic actuator by a first distance corresponding to the second volume of fluid received by the hydraulic actuator. The fluid from the fluid source is directed into the second chamber portion until the piston moves from the second end of the fluid chamber to the first end of the fluid chamber. Thus, a third volume of fluid is introduced into the second chamber portion, and the first volume of fluid is discharged from the first chamber portion. The method also includes directing the first volume of fluid discharged from the first chamber portion into the hydraulic actuator to actuate the hydraulic actuator by a second distance corresponding to the first volume of fluid received by the hydraulic actuator.

These and additional aspects of the present disclosure are set forth in the description that follows, and/or may be learned by a person having ordinary skill in the art by reading the materials herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus according to one or more aspects of the present disclosure.

FIG. 2 is a schematic view of at least a portion of an example implementation of apparatus according to one or more aspects of the present disclosure.

FIG. 3 is a graph related to one or more aspects of the present disclosure.

FIG. 4 is a schematic view of at least a portion of an example implementation of apparatus according to one or more aspects of the present disclosure.

FIG. 5 is a schematic view of at least a portion of an example implementation of apparatus according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. It should also be understood that the terms “first,” “second,” “third,” etc., are arbitrarily assigned, are merely intended to differentiate between two or more parts, fluids, etc., and do not indicate a particular orientation or sequence.

The present disclosure is directed to an apparatus and methods utilizing one or more fluid chambers, having a known or predetermined volume, to meter a fluid that is directed to a fluid actuator to precisely control the fluid actuator. The chamber may comprise a piston slidably disposed therein and movable between opposing ends of the chamber. The piston may divide the chamber into opposing volumes or portions. The chamber may further comprise a fluid port on one side of the piston and fluidly connected with one chamber portion. The fluid port may be operable to receive and discharge the fluid into and out of the chamber portion. The chamber may further comprise another fluid port on an opposing side of the piston and fluidly connected with the other chamber portion. Such fluid port may be operable to receive and discharge the fluid into and out of the other chamber portion. During operations, the fluid may be received by and discharged from one or both of the chamber portions via the corresponding ports and directed to the fluid actuator. Since the volume of each chamber portion is known, a volume of fluid that is discharged from the chamber and received by the fluid actuator is also known. Accordingly, movement or position of the fluid actuator is known based on displacement of the actuator or other volume-to-movement characteristics of the fluid actuator.

Example implementations of apparatus and methods described herein relate generally to utilizing one or more chambers as part of a hydraulic system to meter pressurized hydraulic fluid to control motion of one or more hydraulic actuators at an oil and gas wellsite. An example hydraulic system within the scope of the present disclosure may be operable to direct the hydraulic fluid from a fluid source into the chamber via one of the chamber ports to cause the piston to move between the opposing ends of the chamber to cause the known or predetermined volume of hydraulic fluid to be discharged from the chamber via the other port. The known or predetermined volume of hydraulic fluid may be substantially equal to the volume of the fluid chamber less a volume of the piston. The hydraulic system may be further operable to direct the known or predetermined volume of hydraulic fluid into the hydraulic actuator to actuate the hydraulic actuator by an incremental step or distance corresponding to or associated with the known or predetermined volume of hydraulic fluid received by the hydraulic actuator.

Another hydraulic system within the scope of the present disclosure may be operable to substantially continuously direct the hydraulic fluid from the fluid source alternatingly into opposing chamber portions via the corresponding chamber ports to cause the known or predetermined volumes of fluid to be substantially continuously discharged alternatingly out of the opposing chamber portions. The hydraulic system may be further operable to direct the known or predetermined volumes of hydraulic fluid into the hydraulic actuator to substantially continuously actuate the hydraulic actuator by incremental steps or distances, each corresponding to or associated with the known or predetermined volume of the hydraulic fluid discharged from the chamber and received by the hydraulic actuator.

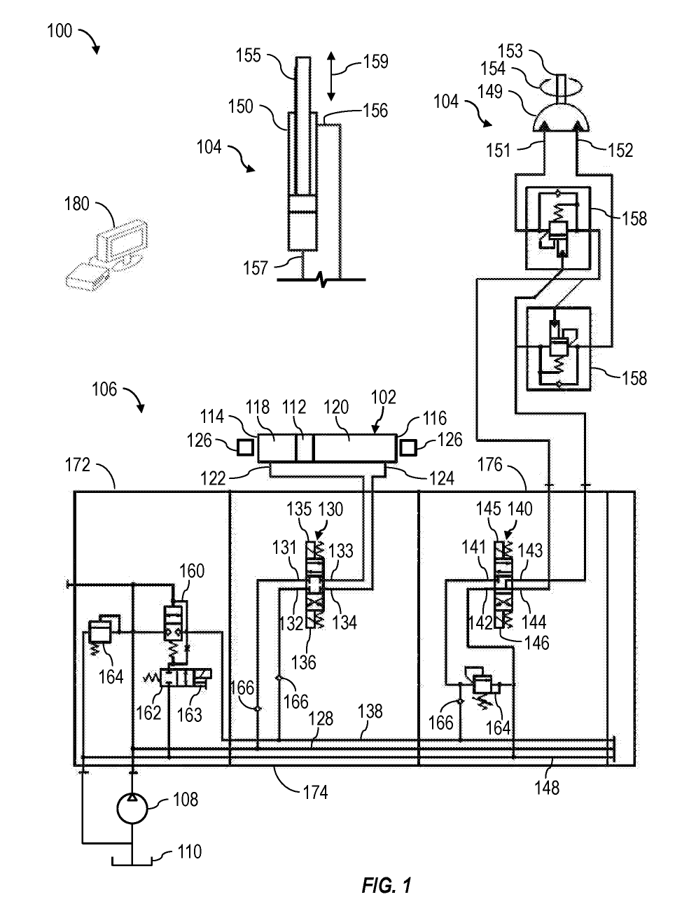

FIG. 1 is a schematic view of at least a portion of an example implementation of a hydraulic system 100 utilizing a fluid chamber 102 for metering hydraulic fluid to precisely control a hydraulic actuator 104 according to one or more aspects of the present disclosure. Volume of the fluid chamber 102 may be predetermined or otherwise known. The hydraulic system 100 may further comprise a hydraulic control system 106 operable to direct or otherwise control flow of the hydraulic fluid from a pump or another source 108 of a pressurized hydraulic fluid into the chamber 102, into the hydraulic actuator 104, and into a fluid container or tank 110.

The chamber 102 may comprise a piston 112 slidably disposed within the chamber 102 and movable between opposing ends 114, 116 of the chamber 102. The piston 112 may divide the chamber 102 into opposing chamber volumes or portions 118, 120. The chamber 102 may further comprise a fluid port 122 on one side of the piston 102 and fluidly connected with the chamber portion 118. The chamber 102 may also comprise another fluid port 124 on an opposing side of the piston 112 and fluidly connected with the other chamber portion 120. During operations, the hydraulic fluid may be received by one of the chamber portions 118, 120 via the corresponding port 122, 124, discharged from the other of the chamber portions 118, 120 via the corresponding port 122, 124, and directed to the actuator 104. Maximum volume of the chamber portion 118 may be substantially equal to the volume of the chamber 102 less the volume of the piston 112 when the piston 112 is positioned against the end 116. Maximum volume of the chamber portion 120 may be substantially equal to the volume of the chamber 102 less the volume of the piston 112 when the piston 112 is positioned against the end 118. Accordingly, the volumes of hydraulic fluid that may be received by the chamber 102 as the piston 112 moves or strokes between the chamber ends 114, 116 may be substantially equal to the maximum volumes of the chamber portions 118, 120. Such volumes may be referred to hereinafter as “stroke volumes.” The chamber 102 and the piston 112 may be configured such that the stroke volumes discharged from each of the chamber portions 118, 120 may be substantially equal. The fluid chamber 102 may be implemented as a rodless hydraulic cylinder, which may comprise, for example, a 2.54 centimeter (1.00 inch) bore and a 2.54 centimeter (1.00 inch) piston stroke. Accordingly, an example stroke volume of the chamber 102 may be about 12.86 cubic centimeters (0.785 cubic inch).

The chamber 102 may include or operate in conjunction with one or more sensors 126 operable to generate a signal or information indicative of position and/or velocity of the piston 112 with respect to the chamber 102 and/or ends 114, 116 of the chamber 102. The signals generated by the sensors 126 as may be utilized to monitor the position and/or velocity of the piston 112. The sensors 126 may be disposed in association with the chamber 102 in a manner permitting sensing of the position and/or velocity of the piston 112. For example, the sensors 126 may be disposed at each end 114, 116 of the chamber 102 to monitor when the piston 112 reaches each end 114, 116 of the chamber 102. One or more of the sensors 126 may also extend along the length of the chamber 102 to monitor the position and/or velocity of the piston 112 along the entire length of the chamber 102. The sensors 126 may be or comprise linear encoders, linear potentiometers, capacitive sensors, inductive sensors, magnetic sensors, linear variable-differential transformers (LVDT), proximity sensors, Hall effect sensors, and/or reed switches, among other examples.

The hydraulic control system 106 may comprise a hydraulic directional control valve 130 operable to selectively fluidly connect the fluid source 108, the chamber 102, and the hydraulic actuator 104. The valve 130 may comprise an inlet port 131 fluidly connected with the fluid source 108 via a pressure line 128, an outlet port 132 fluidly connected with the actuator 104 via a metered fluid supply line 138, a working port 133 fluidly connected with the port 122 of the chamber 102, and another working port 134 fluidly connected with the port 124 of the chamber 102. The valve 130 may be shifted or otherwise operated by opposing actuators 135, 136, such as solenoids, to direct the hydraulic fluid from the fluid source 108 into one of the chamber portions 118, 120 via one of the working ports 133, 134 and to receive the hydraulic fluid from the other chamber portion 118, 120 via the other working port 133, 134. In its idle state, the valve 130 may fluidly isolate the ports 133, 134 from the ports 131, 132, to prevent fluid flow through the valve 130. Activating the actuator 135 may cause the valve 130 to direct the fluid into the chamber portion 118 via the ports 133, 122 and out of the chamber portion 120 and back through the valve 130 via the ports 124, 134. However, activating the actuator 136 may cause the valve 130 to direct the fluid into the chamber portion 120 via the ports 134, 124 and out of the chamber portion 118 and back through the valve 130 via the ports 122, 133. The fluid received from the chamber 102 may be directed to the actuator 104 via the outlet port 132 and the metered fluid supply line 138.

The hydraulic actuator 104 may be or comprise a hydraulic rotary actuator 149, such as a hydraulic motor, a vane actuator, a rotary-linear actuator, a rack-and-pinion actuator, and a helical (i.e., spiral-shaft) actuator, among other examples. The hydraulic rotary actuator 149 may comprise fluid ports 151, 152 operable to receive the hydraulic fluid via the metered fluid supply line 138 and discharge the hydraulic fluid via the drain line 148 to cause the rotary actuator 149 to rotate a shaft 153, as indicated by arrows 154. The hydraulic actuator 104 may also be or comprise a hydraulic linear actuator 150, such as a hydraulic cylinder, comprising a piston-and-rod assembly 155. The linear actuator 150 may comprise fluid ports 156, 157 operable to receive the hydraulic fluid via the metered fluid supply line 138 and discharge the hydraulic fluid via the drain line 148 to cause the piston-and-rod assembly 155 to extend and retract, as indicated by arrows 159. Each type of hydraulic actuator 104 may comprise a predetermined or known actuator displacement, based on size, type, and other design aspects of the hydraulic actuator 104, such as may relate the volume of the received hydraulic fluid to the resulting movement of the hydraulic actuator 104. Accordingly, position and/or movement of the hydraulic actuator 104 may be determined based on the actuator displacement and the volume of the hydraulic fluid received by the hydraulic actuator 104.

Counterbalance or brake valves 158 may be fluidly connected at one or both of the ports 151, 152 of the hydraulic actuator 104. Each counterbalance valve 158 may permit fluid flow out of a corresponding port 151, 152 when a predetermined pressure is detected at the other port 151, 152, and may prevent fluid flow when the predetermined pressure is not detected at the other port 151, 152. Accordingly, the counterbalance valves 158 may be operable to control motion of a load actuated by the hydraulic actuator 104 based on application of fluid pressure at the ports 151, 152. The counterbalance valves 158 may also prevent the hydraulic actuator 104 from running away or drifting due to pressure differentials caused by heavy loads or pressure losses caused by hydraulic line failure or hydraulic fluid leakage.

The hydraulic control system 106 may further comprise another hydraulic directional control valve 140 operable to selectively fluidly connect the valve 130, the actuator 104, and the tank 110. The valve 140 may comprise an inlet port 141 fluidly connected with the outlet port 132 of the valve 130 via the metered fluid line 138, an outlet port 142 fluidly connected with the tank 110 via a drain line 148, a working port 143 fluidly connected with the port 151 of the actuator 104, and another working port 144 fluidly connected with the port 152 of the actuator 104. The valve 140 may be shifted or otherwise operated by opposing actuators 145, 146, such as solenoids, to direct the fluid into the hydraulic actuator 104 via one of the ports 151, 152 and to receive the fluid from the hydraulic actuator 104 via the other port 151, 152. Maintaining the valve 140 in its idle state may fluidly connect the ports 142, 143, 144 and fluidly isolate the port 141 to prevent actuation of the hydraulic actuator 104, while shifting the valve 140 may control the direction of motion of the hydraulic actuator 104. For example, activating the actuator 145 may cause the valve 140 to direct the hydraulic fluid into the hydraulic actuator 104 via the port 151 and out of hydraulic actuator 104 via the port 152 to rotate the shaft 153 in one direction, while activating the actuator 146 may cause the valve 140 to direct the hydraulic fluid into the hydraulic actuator 104 via the port 152 and out of hydraulic actuator 104 via the port 151 to rotate the shaft 153 in an opposing direction. The hydraulic fluid received from the actuator 104 may then be directed to the tank 110 via the outlet port 142 of the valve 140 and the drain line 148.

The hydraulic control system 106 may be set to a metering mode, in which the hydraulic fluid discharged from the fluid source 108 is metered via the chamber 102, as described above, and a manual mode, in which the hydraulic fluid discharged from the fluid source 108 is directed to the hydraulic actuator 104 via the valve 140, while bypassing the valve 130 and chamber 102. The control system 106 may comprise a normally-closed fluid shut-off valve 160 fluidly connected between the pressure line 128 and the metered fluid supply line 138 to selectively set the hydraulic control system 106 to the metering or manual mode. The valve 160 may isolate the fluid lines 128, 138 and may be selectively operated to fluidly connect the fluid lines 128, 138 without the hydraulic fluid first being communicated through the valve 130 and chamber 102. The valve 160 may be a pressure-operated valve. When fluid pressures on opposing sides of the valve 160 are equal, the valve 160 may remain in the closed-flow position and when the fluid pressures on the opposing sides of the valve 160 are not equal, the valve 160 may be shifted to the open-flow position.

The valve 160 may be operated by a normally-closed fluid shut-off valve 162 fluidly connected between the valve 160 and the drain line 148. The valve 162 may isolate the valve 160 and the drain line 148 and may be selectively operated to fluidly connect the valve 160 and the drain line 148 to depressurize one side of the valve 162, shifting the valve 162 to the open-flow position to fluidly connect the pressure line 128 with the metered fluid supply line 138. Accordingly, once the valve 162 is operated, the fluid source 108 may supply the hydraulic fluid directly to the valve 140 via the metered fluid supply line 138 without first being metered by the fluid chamber 102. The valve 162 may be shifted or otherwise operated by an actuator 163, such as a solenoid and/or a manual operator, to selectively operate the valve 160 to switch the hydraulic control system 106 between the metering and manual modes.

The hydraulic control system 106 may further comprise one or more pressure relief valves 164 operable to relieve the pressure line 128 and the metered fluid supply line 138 when excessive pressures are generated, such as to prevent or reduce pressure related damage to components fluidly connected with the fluid lines 128, 138. The hydraulic control system 106 may further comprise one or more check valves 166 operable to control direction of hydraulic fluid flow.

The various components of the hydraulic control system 106 may be fluidly connected via one or more manifolds. For example, the hydraulic control system 106 may include a mode selector manifold 172 having the valves 160, 162 mounted thereto, a fluid metering manifold 174 fluidly connected with the chamber 102 and having the valve 130 mounted thereto, and an actuator control manifold 176 fluidly connected with the hydraulic actuator 104 and having the valve 140 mounted thereto. The manifolds 172, 174, 176 may be mounted together to fluidly join corresponding portions of the pressure line 128, the metered fluid supply line 138, and the drain line 148.

A controller 180 may be operable to monitor and control one or more operations of the hydraulic system 100. The controller 180 may be in communication with the fluid source 108, the valves 130, 140, 162, and the sensors 126 to adjust or otherwise control flow of the hydraulic fluid to control the movement and position of the hydraulic actuator 104. For example, the controller 180 may be operable to control the flow rate and/or pressure generated by the fluid source 108 and/or the frequency at which the valve 130 is shifted between the opposing flow positions to control the speed at which the hydraulic actuator 104 and the load connected to the hydraulic actuator 104 is actuated. The controller 180 may be operable to shift the valve 140 between the opposing flow positions to control the direction of movement of the hydraulic actuator 104 and the load connected to the hydraulic actuator 104. The controller 180 may be operable to activate, deactivate, and control pumping or operating speed of the fluid source 108 and energize or otherwise actuate the valve actuators 135, 136, 145, 146, 163 to permit the controller 180 to shift or operate the fluid valves 130, 140, 162.

The position sensors 126 may be in communication with the controller 180 to permit the controller 180 to receive feedback signals generated by the position sensors 126 and, thus, confirm that the piston 112 has moved between the opposing chamber ends 114, 116 to discharge the known stroke volume of the hydraulic fluid before the valve 130 is shifted to move the piston 112 in the opposing direction. For example, the controller 180 may be operable to cause the valve 130 to direct fluid from the fluid source 108 into one of the chamber ports 122, 124 until the piston 112 reaches one of the chamber ends 114, 116 to cause the stroke volume of the hydraulic fluid to be discharged out of the other port 122, 124. The controller 180 may further cause the valve 130 to direct the discharged stroke volume of the hydraulic fluid into the hydraulic actuator 104 to actuate the hydraulic actuator 104 (e.g., the piston-and-rod assembly 155 or the shaft 153) by a distance corresponding to the stroke volume of the hydraulic fluid received by the hydraulic actuator 104. The distance or movement of the hydraulic actuator 104 may be know or determined based on the displacement of the hydraulic actuator 104.

The controller 180 may be further operable to cause the valve 130 to substantially continuously direct the hydraulic fluid from the fluid source 108 alternatingly into one of the chamber portions 118, 120 via the corresponding chamber ports 122, 124 to cause stroke volumes of the hydraulic fluid to be substantially continuously discharged alternatingly out of the other chamber portion 118, 120 via the corresponding chamber port 122, 124. The controller 180 may also cause the valve 130 to direct the discharged stroke volumes of the hydraulic fluid into the hydraulic actuator 104 to actuate the hydraulic actuator 104 by incremental steps or distances, each corresponding to the stroke volume of the hydraulic fluid received by the hydraulic actuator 104.

The controller 180 may also control the number of times the valve 130 is shifted between the opposing flow positions to control the number of stroke volumes of the hydraulic fluid that are communicated to the hydraulic actuator 104 to control the position of the hydraulic actuator 104 and the load connected to the hydraulic actuator 104. For example, the controller 180 may be operable to store information related to a predetermined number of stroke volumes to be discharged from the chamber 102 or the number of piston strokes to be performed to achieve an intended or predetermined movement or position of the hydraulic actuator 104. The controller 180 may be further operable to record the number the strokes performed by the piston 112 based on the signals generated by the position sensors 126, and cause the valve 130 to stop directing the hydraulic fluid to the chamber 102 when the recorded number of strokes performed by the piston 112 is equal to the predetermined number of strokes.

The position sensors 126 may also generate signals indicative of intermediate piston positions as the piston 112 moves between the opposing chamber ends 114, 116. Such signals may be utilized by the controller 180 to determine volumes of the hydraulic fluid, including volumes that may be less than the stroke volumes, being discharged from the chamber 102 and into the hydraulic actuator 104.

Communication between the controller 180 and the various portions of the hydraulic system 100 may be via wired and/or wireless communication means. However, for clarity and ease of understanding, such communication means are not depicted in FIG. 1, as a person having ordinary skill in the art will appreciate that such communication means are within the scope of the present disclosure.

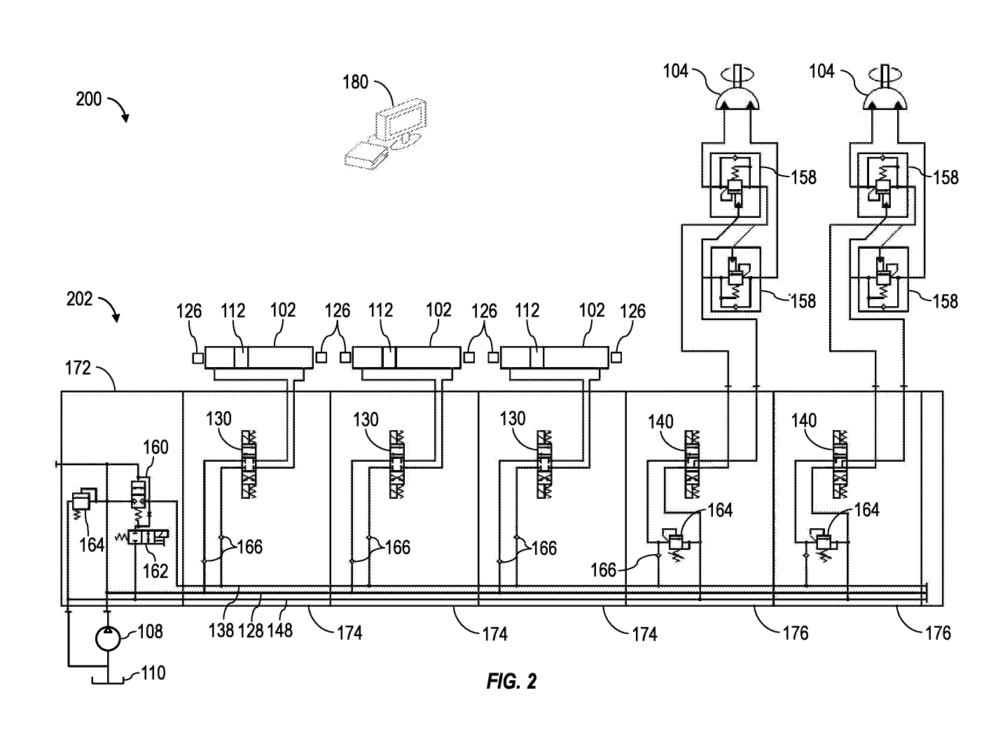

FIG. 2 is a schematic view of at least a portion of an example implementation of a hydraulic system 200 utilizing a plurality of fluid chambers 102 for metering hydraulic fluid to precisely control one or more hydraulic actuators 104 according to one or more aspects of the present disclosure. The hydraulic system 200 comprises one or more similar features of the hydraulic system 100 shown in FIG. 1, including where indicated by like reference numbers, except as described below. The following description refers to FIGS. 1 and 2, collectively.

The hydraulic system 200 may comprise a hydraulic control system 202 operable to direct or otherwise control flow of the hydraulic fluid from the fluid source 108, into the chambers 102, into the hydraulic actuators 104, and into a fluid container or tank 110. Each fluid chamber 102 may be selectively fluidly connected with the fluid source 108 via a corresponding hydraulic directional control valve 130. Each chamber 102 may comprise a piston 112 slidably disposed within the chamber 102 and movable between opposing ends 114, 116 of the chamber 102. Each piston 112 may divide each corresponding chamber 102 into opposing volumes or chamber portions 118, 120. Each chamber 102 may further comprise a fluid port 122 on one side of the piston 102 and fluidly connected with the chamber portion 118, and another fluid port 124 on an opposing side of the piston 112 and fluidly connected with the other chamber portion 120. Each chamber 102 may include one or more sensors 126 operable to generate a signal or information indicative of position and/or velocity of the corresponding piston 112 with respect to the chamber 102 and/or chamber ends 114, 116, such as may be utilized to monitor the position and/or velocity of each piston 112.

Each valve 130 may fluidly connect the fluid source 108 with a corresponding chamber 102 and the hydraulic actuator 104. Each valve 130 may comprise an inlet port 131 fluidly connected with the fluid source 108 via a pressure line 128, an outlet port 132 fluidly connected with the actuator 104 via a metered fluid supply line 138, a working port 133 fluidly connected with the port 122 of the corresponding chamber 102, and another working port 134 fluidly connected with the port 124 of the corresponding chamber 102. Each valve 130 may be shifted or otherwise operated by opposing actuators 135, 136, such as solenoids, to direct the fluid from the fluid source 108 into one of the portions 118, 120 of the corresponding chamber 102 via one of the working ports 133, 134 and to receive the fluid from the other portion 118, 120 via the other working port 133, 134. The fluid received from each chamber 102 may be directed to the actuators 104 via the corresponding valve 130 and the metered fluid supply line 138.

Each hydraulic actuator 104 may be or comprise a hydraulic rotary actuator 149 comprising fluid ports 151, 152 operable to receive the hydraulic fluid from the metered fluid supply line 138 and discharge the hydraulic fluid into the drain line 148 to cause the rotary actuator 149 to rotate a shaft 153. The hydraulic actuator 104 may also be or comprise a hydraulic linear actuator 150 comprising fluid ports 156, 157 operable to receive the hydraulic fluid from the metered fluid supply line 138 and discharge the hydraulic fluid into the drain line 148 to cause the piston-and-rod assembly 155 to extend and retract. Counterbalance or brake valves 158 may be fluidly connected at one or both of the ports 151, 152.

The hydraulic control system 202 may further comprise a plurality of hydraulic directional control valves 140, each operable to selectively fluidly connect the valves 130, the actuators 104, and the tank 110. Each valve 140 may comprise an inlet port 141 fluidly connected with the outlet ports 132 of the valves 130 via a metered fluid supply line 138, an outlet port 142 fluidly connected with the tank 110 via a drain line 148, a working port 143 fluidly connected with the port 151 of the corresponding actuator 104, and another working port 144 fluidly connected with the port 152 of the corresponding actuator 104. Each valve 140 may be shifted or otherwise operated by opposing actuators 145, 146, such as solenoids, to direct the hydraulic fluid into the hydraulic actuator 104 via one of the ports 151, 152 and to receive the hydraulic fluid from the hydraulic actuator 104 via the other port 151, 152. The hydraulic fluid received from the corresponding actuator 104 may then be directed to the tank 110 via the outlet port 142 of the valve 140 and the drain line 148.

The hydraulic control system 202 may be set to a metering mode, in which the hydraulic fluid discharged by the fluid source 108 is metered via one or more of the chambers 102, and a manual mode, in which the hydraulic fluid discharged by the fluid source 108 is directed to one or more of the hydraulic actuators 104 via the valves 140, while bypassing the valves 130 and chambers 102. The control system 202 may comprise a normally-closed fluid shut-off valve 160 operated by a normally-closed fluid shut-off valve 162. When operated by the valve 162, the valve 160 may fluidly connect the pressure line 128 with the metered fluid supply line 138 to supply the pressurized hydraulic fluid directly to the valves 140, such as may permit operation of one or more of the hydraulic actuators 104 without first metering the hydraulic fluid via the chambers 102.

The various components of the hydraulic control system 202 may be fluidly connected via one or more manifolds. For example, the hydraulic control system 202 may include a mode selector manifold 172 having the valves 160, 162 mounted thereto, three fluid metering manifolds 174, each fluidly connected with the corresponding chamber 102 and having the corresponding valve 130 mounted thereto, and two actuator control manifolds 176, each fluidly connected with the corresponding hydraulic actuator 104 and having the corresponding valve 140 mounted thereto. The manifolds 172, 174, 176 may be mounted together to fluidly join corresponding portions of the pressure line 128, the metered fluid supply line 138, and the drain line 148.

A controller 180 may be operable to monitor and control one or more operations of the hydraulic system 200. The controller 180 may be in communication with the fluid source 108, the valves 130, 140, 162, and the sensors 126 to adjust or otherwise control flow of the hydraulic fluid to control the movement and position of the hydraulic actuators 104.

For example, the controller 180 may be operable to cause one or more valves 130 to direct the hydraulic fluid from the fluid source 108 into one of the ports 122, 124 of the corresponding chamber 102 until the piston 112 reaches one of the chamber ends 114, 116 to cause a stroke volume of the hydraulic fluid to be discharged out of the other chamber port 122, 124. The controller 180 may further cause the valves 130 to direct the discharged stroke volumes of the hydraulic fluid into one of the hydraulic actuators 104 to actuate the hydraulic actuator 104 by a distance corresponding to the stroke volume of the hydraulic fluid received by the hydraulic actuator 104.

When two or more valves 130 are operated by the controller 180 to direct the hydraulic fluid into and out of the corresponding chambers 102, the controller 180 may operate such valves 130 out of phase with respect to each other such that the stroke volumes of the hydraulic fluid discharged by the corresponding chambers 102 are introduced into the operated hydraulic actuator 104 out of phase with respect to each other. Such control of the valves 130 may smooth out or reduce the stepping or jerky motion of the hydraulic actuator 104, which may be caused if the stroke volumes were introduced into the hydraulic actuator 104 at the same time or while in phase.

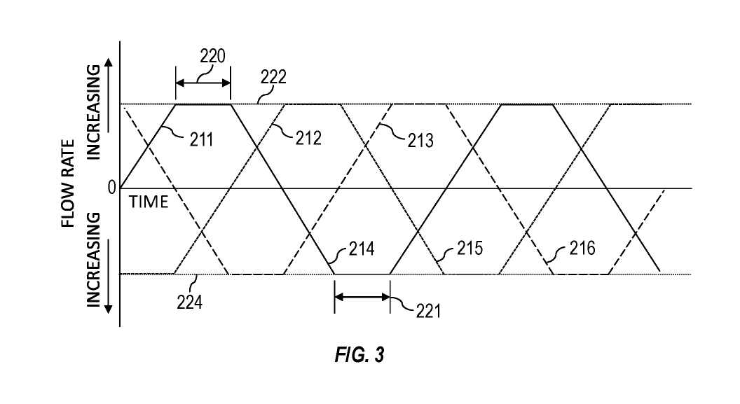

FIG. 3 is a graph showing example flow rate profiles of the stroke volumes of the hydraulic fluid discharged by the three chambers 102 of the hydraulic system 200 shown in FIG. 2 and received by one of the hydraulic actuators 104 while the valves 130 are being operated out of phase. The following description refers to FIGS. 1-3, collectively.

The graph depicts flow rates of the hydraulic fluid discharged from each chamber 102, shown along the vertical axis, with respect to time, shown along the horizontal axis. Curve 211 represents flow rate of the hydraulic fluid discharged from a first one of the chambers 102 as the corresponding piston 112 is moving in a first direction. While operating in the metering mode, the piston 112 of the first chamber 102 may progressively increase or accelerate to progressively increase the flow rate of hydraulic fluid discharged until a predetermined flow rate is reached. The piston 112 may then continue moving at a substantially constant velocity to maintain the flow rate substantially constant for a period of time 220. Thereafter, the velocity of the piston 112 may progressively decrease to progressively decrease the flow rate until the flow rate reaches zero. As shown in FIG. 3, the curve 211 comprises an upwardly sloping portion representing the progressively increasing flow rate of the discharged hydraulic fluid, a downwardly sloping portion representing the progressively decreasing flow rate of the discharged hydraulic fluid, and a substantially horizontal portion interposing the first and second portions, representing the substantially constant flow rate of the discharged hydraulic fluid.

Curve 214 represents flow rate of the hydraulic fluid discharged from the first one of the chambers 102 as the corresponding piston 112 is moving in a second direction, opposite the first direction. While operating in the metering mode, the piston 112 of the first chamber 102 may progressively increase or accelerate to progressively increase the flow rate of hydraulic fluid discharged until a predetermined flow rate is reached. The piston 112 may then continue moving at a substantially constant velocity to maintain the flow rate of the discharged hydraulic fluid substantially constant for a period of time 221. Thereafter, the velocity of the piston 112 may progressively decrease to progressively decrease the flow rate of the hydraulic fluid discharged until the flow rate reaches zero. As shown in FIG. 3, the curve 214 comprises a downwardly sloping portion representing the progressively increasing flow rate of the discharged hydraulic fluid, an upwardly sloping portion representing the progressively decreasing flow rate of the discharged hydraulic fluid, and a substantially horizontal portion interposing the first and second portions, representing the substantially constant flow rate of the discharged hydraulic fluid.

Curves 212, 215 represent flow rates of the hydraulic fluid discharged from a second one of the chambers 102, while curves 213, 216 represent flow rates of the hydraulic fluid discharged from a third one of the chambers 102. Similarly as described above with respect to the curves 211, 214, the velocity of the pistons 112 disposed within the second and third chambers 102 may progressively increase to progressively increase flow rates of the hydraulic fluid discharged from the second and third chambers 102, continue moving at a substantially constant velocity to maintain the flow rates of the hydraulic fluid discharged from the second and third chambers 102, and progressively decrease to progressively decrease the flow rates of the hydraulic fluid discharged from the second and third chambers 102.

The controller 180 may be operable to synchronize the operation of first and second valves 130 associated with the first and second chambers 102 such that the combined flow rate discharged from the first and second chambers 102 may be maintained substantially constant. Similarly, the controller 180 may be operable to synchronize the operation of the second and third valves 130 associated with the second and third chambers 102 such that the combined flow rate discharged from the second and third chambers 102 may also be maintained substantially constant. For example, as the flow rate discharged from the first chamber 102 progressively decreases, the flow rate discharged from the second chamber 102 may progressively increase, perhaps by a proportional amount and/or rate, such that the combined flow rate discharged from the first and second chambers 102 may be maintained substantially constant. Similarly, as the flow rate discharged from the second chamber 102 progressively decreases, the flow rate discharged from the third chamber 102 may progressively increase, perhaps by a proportional amount and/or rate, such that the combined flow rate of the second and third chambers 102 may be maintained substantially constant. Accordingly, the substantially horizontal portions of the curves 211, 212, 213, representing the substantially constant flow discharged from each chamber 102 while the pistons 112 are moving in the first direction, may not occur simultaneously or otherwise overlap. Similarly, the substantially horizontal portions of the curves 214, 215, 216, representing the substantially constant flow rates discharged by each chamber 102 while the pistons 112 are moving in the second direction, may also not occur simultaneously or otherwise overlap.

The hydraulic fluid collectively discharged from the chambers 102 may be communicated to the operated hydraulic actuator 104 via the metered fluid supply line 138. The substantially constant flow rate may reduce pressure spikes or fluctuations at the hydraulic actuator 104 and/or reduce the stepping or jerky motion of the hydraulic actuator 104. The combined flow rates of the three chambers 102 while the pistons 112 are moving in the first direction are shown by a curve 222, and the combined flow rates of the three chambers 102 while the pistons 112 are moving in the second direction are shown by a curve 224.

The controller 180 may also be operable to synchronize the operation of the first, second, and third valves 130 such that the constant flow portions of each curve 211-216 partially overlap, but are not substantially in phase, which may also reduce pressure spikes and/or reduce the stepping or jerky motion of the hydraulic actuator 104. Furthermore, one or more aspects described above with respect to synchronizing the movement of the pistons 112 out of phase with respect to each other to achieve a substantially constant combined flow rate may also be applicable or readily adaptable to other hydraulic systems within the scope of the present disclosure, including implementations comprising fewer or more than three chambers 102 and corresponding valves 130.

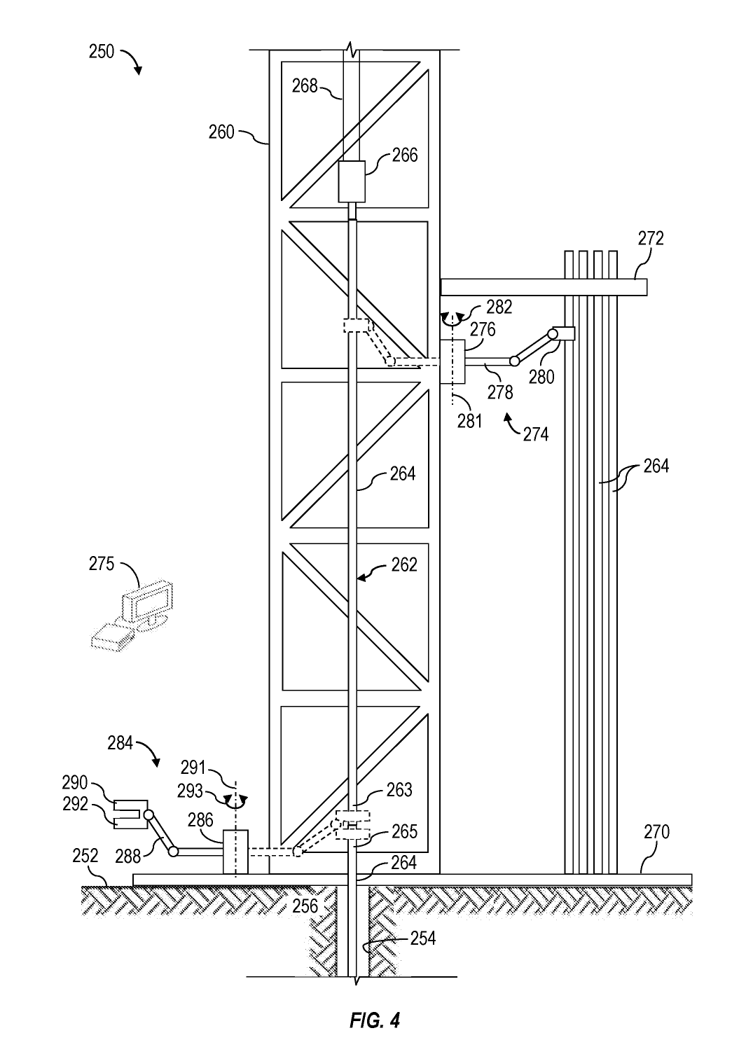

FIG. 4 is a schematic view of at least a portion of an example wellsite system 250 according to one or more aspects of the present disclosure, representing an example environment in which the hydraulic systems 100, 200, shown in FIGS. 1 and 2, may be implemented. The following description refers to FIGS. 1-4, collectively.

The wellsite system 250 may be or comprise a drilling system located at a wellsite surface 252 above a wellbore 254 extending into a rock formation 256. The wellsite system 250 may comprise a bottom hole assembly (BHA) (not shown) suspended from a mast or derrick 260 into the wellbore 254 via a drill string 262. The drill string 262 may be or comprise a plurality of drill pipes 264 or other drilling members threadedly engaged to collectively form the drill string 262. The drill string 262 may be rotated by a top drive 266 suspended from the derrick 260 and conveyed vertically by a drawworks (not shown) via a cable 268 to advance the wellbore 254. The wellsite system 250 may contain a plurality of the drill pipes 264 retained on a pipe rack setback 270 and maintained in vertical position by a racking board 272.

The drill pipes 264 may be moved one at a time from the racking board 272 to a position directly above a previously lowered drill pipe 264 and directly below the top drive 266 by a transfer mechanism 274 coupled with the derrick 260 adjacent the plurality of drill pipes 264. The transfer mechanism 274 may comprise a rotary actuator 276 connected with an extendable arm 278 that may terminate with a gripper 280. The transfer mechanism 274 may be in communication with and operated by a controller 275 located at the wellsite system 250. The controller 275 may be or comprise the controller 180 described above and the rotary actuator 276 may be or comprise the hydraulic rotary actuator 149 described above. The rotary actuator 276 may be operated by the controller 275 via one of the hydraulic control systems 106, 202 (not shown in FIG. 4) fluidly connected with the rotary actuator 276 and/or other portions of the transfer mechanism 274.

As described above, the controller 275 may be in communication with the valves 130, 140, 162 and the sensors 126 of the hydraulic control systems 106, 202 to adjust or otherwise control flow of the hydraulic fluid to control the movement and position of the transfer mechanism 274. The hydraulic fluid may be metered via one or more chambers 102 to precisely control the volume of the hydraulic fluid received by the rotary actuator 276. For example, during drilling operations, the controller 275 may cause the rotary actuator 276 to rotate about its axis 281, as indicated by arrows 282, to orient or move the extendable arm 278 toward an intended drill pipe 264 being stored on the pipe rack setback 270, extend the arm 278 until the gripper 280 is disposed about the drill pipe 264, and close or otherwise operate the gripper 280 to hold the drill pipe 264. Thereafter, the controller 275 may cause the arm 278 to lift the drill pipe 264 and the rotary actuator 276 to rotate the arm 278 about its axis 281 to a position in which the drill pipe 264 is directly above a previously lowered drill pipe 264 and directly below the top drive 266. The later position of the arm 278 and the gripper 280 is shown in phantom lines. The metering of the hydraulic fluid via one or more chambers 102 may permit precise movement or positioning of the rotary actuator 276, such as may permit precise movement or positioning of the drill pipes 264 from the pipe rack setback 270 to a position in which the moved drill pipe 264 is directly above the previously lowered drill pipe 264. For example, the controller 275 may be programmed with a volume of hydraulic fluid that may be discharged from the chamber 102 and/or with a number of strokes of the piston 112 that may be performed to achieve the intended rotation or movement of the rotary actuator 276.

As further shown in FIG. 4, an iron roughneck 284 may be utilized to make up and break out the drill pipes 264. The iron roughneck 284 may comprise a rotary actuator 286 connected with an extendable arm 288 that may terminate with a spanner 290 and wrench 292. The iron roughneck 284 may be in communication with and operated by the controller 275. The rotary actuator 286 may be or comprise the rotary actuator 149 described above and may be operated by the controller 275 via one of the hydraulic control systems 106, 202 (not shown in FIG. 4) fluidly connected with the rotary actuator 286 and/or other portions of the iron roughneck 284.

As described above, the controller 275 may be in communication with the valves 130, 140, 162 and the sensors 126 of the hydraulic control systems 106, 202 to adjust or otherwise control flow of the hydraulic fluid to control the movement and position of the iron roughneck 284. The hydraulic fluid may be metered via one or more chambers 102 to precisely control the volume of the hydraulic fluid received by the rotary actuator 286. For example, during drilling operations, the controller 275 may cause the rotary actuator 286 to rotate about its axis 291, as indicated by arrows 293, to orient or move the extendable arm 288 toward the recently moved and lowered drill pipes 264 and extend the arm 288 until the spanner 290 is disposed about a lower joint 263 of the moved drill pipe 264 and the wrench 292 is disposed about the upper joint 265 of the lowered drill pipe 264. The later position of the arm 288, the spanner 290, and the wrench 292 is shown in phantom lines. Once the spanner 290 and wrench 292 are in position, the controller 275 may operate the spanner 290 and wrench 292 to make up the drill pipes 264. Once the drill pipes 264 are made up, the controller 275 may cause the rotary actuator 286 to rotate the arm 288 about its axis 291 to an intended position away from the drill string 262. The metering of the hydraulic fluid via one or more chambers 102 may permit precise movement or positioning of the rotary actuator 286, such as may permit precise movement or positioning of the spanner 290 and wrench 292 about the lower and upper pipe joints 263, 265. For example, the controller 275 may be programmed with a volume of hydraulic fluid that may be discharged from the chamber 102 and/or with a number of strokes of the piston 112 that may be performed to achieve the intended rotation or movement of the rotary actuator 286.

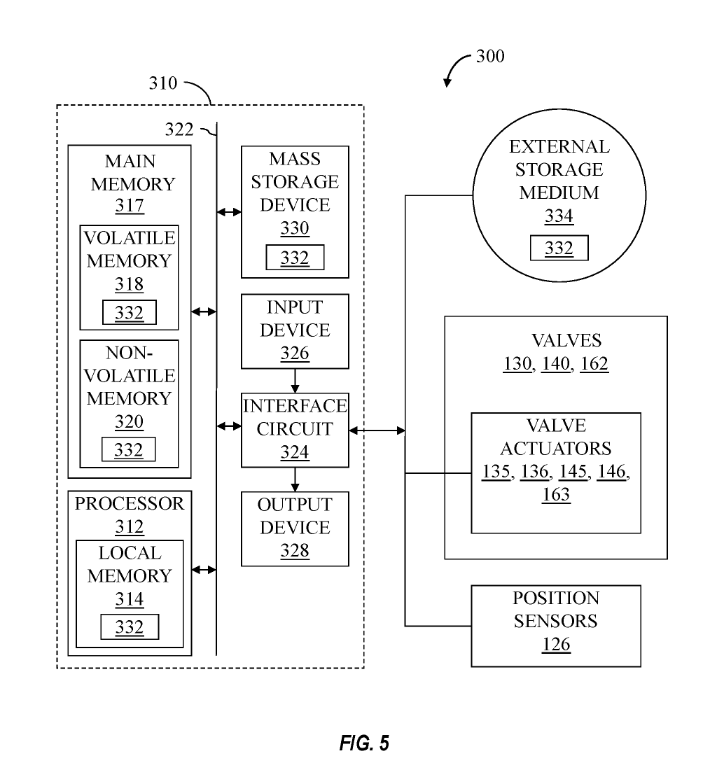

Various portions of the apparatus described above and shown in FIGS. 1-4, may collectively form and/or be controlled by a control system, such as may be operable to monitor and/or control at least some operations of the hydraulic control systems 106, 202, the hydraulic systems 100, 200, and the wellsite system 250, including the actuators 104, 276, 286. FIG. 5 is a schematic view of at least a portion of an example implementation of such control system 300 according to one or more aspects of the present disclosure. The following description refers to one or more of FIGS. 1-5.

The control system 300 may comprise a controller 310, which may be in communication with various portions of the hydraulic systems 100, 200 and the wellsite system 250, including the valve actuators 135, 136, 145, 146, 163 to operate the corresponding valves 130, 140, 162 and the position sensors 126 to determine the volume of hydraulic fluid being discharged from the chamber 102. For clarity, these and other components in communication with the controller 310 will be collectively referred to hereinafter as “actuator and sensor equipment.” The controller 310 may be operable to receive coded instructions 332 from the human operators and signals generated by the position sensors 126, process the coded instructions 332 and the signals, and communicate control signals to the actuators 135, 136, 145, 146, 163 to implement at least a portion of one or more example methods and/or processes described herein, and/or to implement at least a portion of one or more of the example systems described herein. The controller 310 may be or comprise the controller 180, 275 described above.

The controller 310 may be or comprise, for example, one or more processors, special-purpose computing devices, servers, personal computers (e.g., desktop, laptop, and/or tablet computers) personal digital assistant (PDA) devices, smartphones, internet appliances, and/or other types of computing devices. The controller 310 may comprise a processor 312, such as a general-purpose programmable processor. The processor 312 may comprise a local memory 314, and may execute coded instructions 332 present in the local memory 314 and/or another memory device. The processor 312 may execute, among other things, the machine-readable coded instructions 332 and/or other instructions and/or programs to implement the example methods and/or processes described herein. The programs stored in the local memory 314 may include program instructions or computer program code that, when executed by an associated processor, facilitate the hydraulic systems 100, 200 and the wellsite system 250 to perform the example methods and/or processes described herein. The processor 312 may be, comprise, or be implemented by one or more processors of various types suitable to the local application environment, and may include one or more of general-purpose computers, special-purpose computers, microprocessors, digital signal processors (DSPs), field-programmable gate arrays (FPGAs), application-specific integrated circuits (ASICs), and processors based on a multi-core processor architecture, as non-limiting examples. Of course, other processors from other families are also appropriate.

The processor 312 may be in communication with a main memory 317, such as may include a volatile memory 318 and a non-volatile memory 320, perhaps via a bus 322 and/or other communication means. The volatile memory 318 may be, comprise, or be implemented by random access memory (RAM), static random access memory (SRAM), synchronous dynamic random access memory (SDRAM), dynamic random access memory (DRAM), RAMBUS dynamic random access memory (RDRAM), and/or other types of random access memory devices. The non-volatile memory 320 may be, comprise, or be implemented by read-only memory, flash memory, and/or other types of memory devices. One or more memory controllers (not shown) may control access to the volatile memory 318 and/or non-volatile memory 320.

The controller 310 may also comprise an interface circuit 324. The interface circuit 324 may be, comprise, or be implemented by various types of standard interfaces, such as an Ethernet interface, a universal serial bus (USB), a third generation input/output (3GIO) interface, a wireless interface, a cellular interface, and/or a satellite interface, among others. The interface circuit 324 may also comprise a graphics driver card. The interface circuit 324 may also comprise a communication device, such as a modem or network interface card to facilitate exchange of data with external computing devices via a network (e.g., Ethernet connection, digital subscriber line (DSL), telephone line, coaxial cable, cellular telephone system, satellite, etc.). One or more of the actuator and sensor equipment may be connected with the controller 310 via the interface circuit 324, such as may facilitate communication between the actuator and sensor equipment and the controller 310.

One or more input devices 326 may also be connected to the interface circuit 324. The input devices 326 may permit the human operators to enter the coded instructions 332, including control commands, operational set-points, and/or other data for use by the processor 312. The operational set-points may include, as non-limiting examples, flow rate of the hydraulic fluid, pressure of the hydraulic fluid, frequency at which the valves 130 are shifted, direction of movement of the hydraulic actuators 104, 276, 286, position, distance, or range of movement of the hydraulic actuators 104, 276, 286, volume of hydraulic fluid to be metered by the chamber 102, number of stroke volumes to be discharged from the chamber 102, such as to control movement or operation of the hydraulic actuators 104, 276, 286, or other hydraulically operated devices of the wellsite system 250. The input devices 326 may be, comprise, or be implemented by a keyboard, a mouse, a touchscreen, a track-pad, a trackball, an isopoint, and/or a voice recognition system, among other examples.

One or more output devices 328 may also be connected to the interface circuit 324. The output devices 328 may be, comprise, or be implemented by display devices (e.g., a liquid crystal display (LCD), a light-emitting diode (LED) display, or cathode ray tube (CRT) display), printers, and/or speakers, among other examples. The controller 310 may also communicate with one or more mass storage devices 330 and/or a removable storage medium 334, such as may be or include floppy disk drives, hard drive disks, compact disk (CD) drives, digital versatile disk (DVD) drives, and/or USB and/or other flash drives, among other examples.

The coded instructions 332 may be stored in the mass storage device 330, the main memory 317, the local memory 314, and/or the removable storage medium 334. Thus, the controller 310 may be implemented in accordance with hardware (perhaps implemented in one or more chips including an integrated circuit, such as an ASIC), or may be implemented as software or firmware for execution by the processor 312. In the case of firmware or software, the implementation may be provided as a computer program product including a non-transitory, computer-readable medium or storage structure embodying computer program code (i.e., software or firmware) thereon for execution by the processor 312.

The coded instructions 332 may include program instructions or computer program code that, when executed by the processor 312, may cause the hydraulic systems 100, 200 and/or the wellsite system 250 to perform methods, processes, and/or routines described herein. For example, the controller 310 may receive, process, and record the operational set-points and commands entered by the human operator and the signals generated by the position sensors 126. Based on the received operational set-points, commands, and the signals, the controller 310 may send signals or information to the various valve actuators 135, 136, 145, 146, 163 to automatically perform and/or undergo one or more operations or routines described herein or otherwise within the scope of the present disclosure. For example, the controller 310 may be operable to cause the transfer mechanism 274 and the iron roughneck 284 perform and/or undergo one or more operations or routines described herein.

In view of the entirety of the present disclosure, including the figures and the claims, a person having ordinary skill in the art will readily recognize that the present disclosure introduces an apparatus comprising: (A) a hydraulic actuator; (B) a fluid chamber comprising a piston slidably movable between first and second ends of the fluid chamber and dividing the chamber into first and second chamber portions; and (C) a hydraulic directional control valve operable to: (i) direct a fluid from a fluid source into the first chamber portion to cause a first volume of fluid to be discharged out of the second chamber portion into the hydraulic actuator to actuate the hydraulic actuator by a first distance corresponding to the first volume of fluid received by the hydraulic actuator; and (ii) direct the fluid from the fluid source into the second chamber portion to cause a second volume of fluid to be discharged out of the first chamber portion into the hydraulic actuator to actuate the hydraulic actuator by a second distance corresponding to the second volume of fluid received by the hydraulic actuator.

The fluid chamber may be or comprise a rodless hydraulic cylinder.

The hydraulic actuator may be or comprise a hydraulic rotary actuator or a hydraulic cylinder.

The first and second volumes of fluid may be substantially equal.

The apparatus may further comprise: (A) a position sensor disposed in association with the fluid chamber and operable to generate a signal indicative of position of the piston within the fluid chamber; and (B) a controller comprising a processor and a memory storing computer program code, wherein the controller is operable to receive the signal from the position sensor and operate the hydraulic directional control valve based on the received signal to direct the fluid from the fluid source into one of the first and second chamber portions. The controller may be operable to control the hydraulic directional control valve based on the received signal to substantially continuously direct the fluid from the fluid source alternatingly into one of the first and second chamber portions to cause volumes of fluid to be substantially continuously discharged alternatingly out of the other of the first and second chamber portions and into the hydraulic actuator to substantially continuously actuate the hydraulic actuator by incremental distances corresponding to the volumes of the fluid received by the hydraulic actuator. The controller may also or instead be operable to: store information related to a predetermined number of movements of the piston between the first and second ends of the fluid chamber to be performed to achieve a predetermined movement of the hydraulic actuator; record the number the movements performed by the piston based on the signal generated by the position sensor; and cause the hydraulic directional control valve to stop directing fluid to the fluid chamber when the recorded number of movements performed by the piston is equal to the predetermined number of movements of the piston.

The hydraulic actuator, the fluid chamber, and the hydraulic directional control valve may form at least a portion of a device operable to move drill pipe on a wellsite.

The present disclosure also introduces an apparatus comprising: (A) a hydraulic actuator; (B) a fluid chamber comprising: (i) a piston slidably movable between first and second ends of the fluid chamber; (ii) a first port extending into the fluid chamber on one side of the piston; and (iii) a second port extending into the fluid chamber on an opposing side of the piston; and (C) a hydraulic directional control valve comprising: (i) a first port fluidly connected with a fluid source; (ii) a second port fluidly connected with the hydraulic actuator; (iii) a third port fluidly connected with the first port of the fluid chamber; and (iv) a fourth port fluidly connected with the second port of the fluid chamber. The hydraulic directional control valve may be operable to: direct a fluid from the fluid source into the first port of the fluid chamber until the piston reaches the first end to cause a volume of fluid to be discharged out of the second port of the fluid chamber; and direct the discharged volume of fluid into the hydraulic actuator to actuate the hydraulic actuator by a distance corresponding to the volume of fluid received by the hydraulic actuator.

The fluid chamber may be or comprise a rodless hydraulic cylinder.

The hydraulic actuator may be or comprise a hydraulic rotary actuator or a hydraulic cylinder.

The volume of fluid may be substantially equal to an internal volume of the fluid chamber.

The hydraulic directional control valve may be a first hydraulic directional control valve, and the apparatus may further comprise a second hydraulic directional control valve comprising: a first port fluidly connected with the second port of the first hydraulic directional control valve; a second port; a third port fluidly connected with a first port of the hydraulic actuator; and a fourth port fluidly connected with a second port of the hydraulic actuator. The second hydraulic directional control valve may be operable to direct the volume of fluid from the first hydraulic directional control valve into the first port of the hydraulic actuator to actuate the hydraulic actuator in a first direction by the distance corresponding to the volume of fluid received by the hydraulic actuator.

The fluid chamber may be a first fluid chamber, the hydraulic directional control valve may be a first hydraulic directional control valve, the volume of fluid may be a first volume of fluid, the distance may be a first distance, and the apparatus may further comprise: (A) a second fluid chamber comprising: (i) a piston slidably movable between first and second ends of the second fluid chamber; (ii) a first port extending into the second fluid chamber on one side of the piston of the second fluid chamber; and (iii) a second port extending into the second fluid chamber on an opposing side of the piston of the second fluid chamber; and (B) a second hydraulic directional control valve comprising: (i) a first port fluidly connected with the fluid source; (ii) a second port fluidly connected with the hydraulic actuator; (iii) a third port fluidly connected with the first port of the second fluid chamber; and (iv) a fourth port fluidly connected with the second port of the second fluid chamber. The second hydraulic directional control valve may be operable to: direct the fluid from the fluid source into the first port of the second fluid chamber until the piston of the second chamber reaches the first end of the second chamber to cause a second volume of fluid to be discharged out of the second port of the second fluid chamber; and direct the second volume of fluid discharged from the second fluid chamber into the hydraulic actuator to actuate the hydraulic actuator by a second distance corresponding to the second volume of fluid received by the hydraulic actuator from the second fluid chamber. In such implementations, among others within the scope of the present disclosure, the first and second hydraulic directional control valves may be operable out of phase with respect to each other such that the volumes of fluid discharged by each of the first and second chambers are introduced into the hydraulic actuator out of phase with respect to each other.

The apparatus may further comprise a position sensor disposed in association with the fluid chamber and operable to generate a signal indicative of position of the piston within the fluid chamber. The apparatus may further comprise a controller comprising a processor and a memory storing computer program code, wherein the controller is operable to receive the signal from the position sensor and operate the hydraulic directional control valve based on the received signal to direct the fluid from the fluid source into one of the first and second ports of the fluid chamber. The controller may be operable to control the hydraulic directional control valve based on the received signal to substantially continuously direct the fluid from the fluid source alternatingly into one of the first and second ports of the fluid chamber to cause volumes of fluid to be substantially continuously discharged alternatingly out of the other of the first and second ports of the fluid chamber and into the hydraulic actuator to substantially continuously actuate the hydraulic actuator by distances corresponding to the volumes of the fluid received by the hydraulic actuator. The controller may also or instead be operable to: store information related to a predetermined number of strokes of the piston to be performed to achieve a predetermined movement of the hydraulic actuator; record the number the strokes performed by the piston based on the signal generated by the position sensor; and cause the hydraulic directional control valve to stop directing fluid to the chamber when the recorded number of strokes performed by the piston is equal to the predetermined number of strokes.

The hydraulic actuator, the fluid chamber, and the hydraulic directional control valve may form a portion of a well drilling system comprising a device operable to move a drill pipe, and the hydraulic actuator may be operable to actuate the device to move the drill pipe.

The present disclosure also introduces a method comprising: (A) directing a fluid from a fluid source into a first chamber portion of a fluid chamber until a piston dividing the fluid chamber into the first chamber portion and a second chamber portion moves from a first end of the fluid chamber to a second end of the fluid chamber to: (i) introduce a first volume of fluid into the first chamber portion; and (ii) discharge a second volume of fluid from the second chamber portion; (B) directing the second volume of fluid discharged from the second chamber portion into a hydraulic actuator to actuate the hydraulic actuator by a first distance corresponding to the second volume of fluid received by the hydraulic actuator; (C) directing the fluid from the fluid source into the second chamber portion until the piston moves from the second end of the fluid chamber to the first end of the fluid chamber to: (i) introduce a third volume of fluid into the second chamber portion; and (ii) discharge the first volume of fluid from the first chamber portion; and (D) directing the first volume of fluid discharged from the first chamber portion into the hydraulic actuator to actuate the hydraulic actuator by a second distance corresponding to the first volume of fluid received by the hydraulic actuator.

The first volume of fluid may be substantially equal to an internal volume of the first chamber portion, and the second and third volumes of fluid may be substantially equal to an internal volume of the second chamber portion.

The first, second, and third volumes of fluid may be substantially equal.

The hydraulic actuator may be or comprise a hydraulic rotary actuator or a hydraulic cylinder.

The first and second distances may be substantially equal.

The method may further comprise: directing the first and second volumes of fluid discharged from the first and second chamber portions into a first port of the hydraulic actuator to actuate the hydraulic actuator in a first direction; and directing the first and second volumes of fluid discharged from the first and second chamber portions into a second port of the hydraulic actuator to actuate the hydraulic actuator in a second direction. In such implementations, among others within the scope of the present disclosure, the method may further comprise directing the first and second volumes of fluid discharged from the hydraulic actuator into a fluid storage container.

The fluid chamber may comprise a position sensor in signal communication with a controller comprising a processor and a memory storing computer program code, and the method may further comprise one or more of: generating a signal with the position sensor indicative of position of the piston within the fluid chamber; receiving the signal by the controller; and operating with the controller a hydraulic directional control valve based on the signal to direct the fluid from the fluid source into one of the first and second chamber portions. In such implementations, among others within the scope of the present disclosure, the method may further comprise operating the hydraulic directional control valve to: direct the fluid from the fluid source alternatingly into one of the first and second chamber portions to cause volumes of fluid to be substantially continuously discharged alternatingly out of the other of the first and second chamber portions; and direct the volumes of fluid discharged from the first and second chamber portions into the hydraulic actuator to substantially continuously actuate the hydraulic actuator by incremental distances corresponding to the volumes of the fluid received by the hydraulic actuator.

The fluid chamber may be a first fluid chamber, the hydraulic actuator may be fluidly connected with the first fluid chamber and a second fluid chamber, and the method may further comprise operating the first and second fluid chambers out of phase with respect to each other such that the volumes of fluid discharged by each of the first and second fluid chambers are introduced into the hydraulic actuator out of phase with respect to each other.

The hydraulic actuator and the fluid chamber may form at least a portion of a pipe moving device utilized on an oilfield drill rig, and the method may further comprise directing the fluid from the fluid source alternatingly into one of the first and second chamber portions to cause volumes of fluid to be substantially continuously discharged alternatingly out of the other of the first and second chamber portions into the hydraulic actuator to substantially continuously actuate the hydraulic actuator until the pipe moving device moves a drill pipe from a first position to a second position.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to permit the reader to quickly ascertain the nature of the technical disclosure. It is submitted with the understanding that it will not be used to interpret or limit the scope or meaning of the claims.

What is claimed is:

1. An apparatus comprising:
a hydraulic actuator;
a fluid chamber comprising a piston slidably movable between first and second ends of the fluid chamber and dividing the chamber into first and second chamber portions; and
a hydraulic directional control valve operable to:
direct a fluid from a fluid source into the first chamber portion to cause a first volume of fluid to be discharged out of the second chamber portion into the hydraulic actuator to actuate the hydraulic actuator by a first distance corresponding to the first volume of fluid received by the hydraulic actuator; and
direct the fluid from the fluid source into the second chamber portion to cause a second volume of fluid to be discharged out of the first chamber portion into the hydraulic actuator to actuate the hydraulic actuator by a second distance corresponding to the second volume of fluid received by the hydraulic actuator.

2. The apparatus of claim 1 wherein the fluid chamber is or comprises a rodless hydraulic cylinder.

3. The apparatus of claim 1 wherein the hydraulic actuator is or comprises a hydraulic rotary actuator.

4. The apparatus of claim 1 wherein the hydraulic actuator is or comprises a hydraulic cylinder.

5. The apparatus of claim 1 wherein the first and second volumes of fluid are substantially equal.

6. The apparatus of claim 1 further comprising:
a position sensor disposed in association with the fluid chamber and operable to generate a signal indicative of position of the piston within the fluid chamber; and
a controller comprising a processor and a memory storing computer program code, wherein the controller is operable to:
receive the signal from the position sensor; and
operate the hydraulic directional control valve based on the received signal to direct the fluid from the fluid source into one of the first and second chamber portions.

7. The apparatus of claim 6 wherein the controller is operable to control the hydraulic directional control valve based on the received signal to substantially continuously direct the fluid from the fluid source alternatingly into one of the first and second chamber portions to cause volumes of fluid to be substantially continuously discharged alternatingly out of the other of the first and second chamber portions and into the hydraulic actuator to substantially continuously actuate the hydraulic actuator by incremental distances corresponding to the volumes of the fluid received by the hydraulic actuator.

8. The apparatus of claim 6 wherein the controller is operable to:
store information related to a predetermined number of movements of the piston between the first and second ends of the fluid chamber to be performed to achieve a predetermined movement of the hydraulic actuator;
record the number the movements performed by the piston based on the signal generated by the position sensor; and
cause the hydraulic directional control valve to stop directing fluid to the fluid chamber when the recorded number of movements performed by the piston is equal to the predetermined number of movements of the piston.

9. The apparatus of claim 1 wherein the hydraulic actuator, the fluid chamber, and the hydraulic directional control valve form at least a portion of a device operable to move drill pipe on a wellsite.

10. An apparatus comprising:
a hydraulic actuator;
a fluid chamber comprising:
a piston slidably movable between first and second ends of the fluid chamber;
a first port extending into the fluid chamber on one side of the piston; and
a second port extending into the fluid chamber on an opposing side of the piston; and
a hydraulic directional control valve comprising:
a first port fluidly connected with a fluid source;
a second port fluidly connected with the hydraulic actuator;
a third port fluidly connected with the first port of the fluid chamber; and
a fourth port fluidly connected with the second port of the fluid chamber;
wherein the hydraulic directional control valve is operable to:
direct a fluid from the fluid source into the first port of the fluid chamber until the piston reaches the first end to cause a volume of fluid to be discharged out of the second port of the fluid chamber; and
direct the discharged volume of fluid into the hydraulic actuator to actuate the hydraulic actuator by a distance corresponding to the volume of fluid received by the hydraulic actuator.

11. The apparatus of claim 10 wherein:
the fluid chamber is or comprises a rodless hydraulic cylinder;
the hydraulic actuator is or comprises at least one of a hydraulic rotary actuator and/or a hydraulic cylinder;
the volume of fluid is substantially equal to an internal volume of the fluid chamber;
the fluid chamber, the piston, the hydraulic directional control valve, the volume of fluid, and the distance are respectively a first fluid chamber, a first piston, a first hydraulic directional control valve, a first volume of fluid, and a first distance;
the apparatus further comprises a second fluid chamber comprising:
a second piston slidably movable between first and second ends of the second fluid chamber;
a first port extending into the second fluid chamber on one side of the second piston; and
a second port extending into the second fluid chamber on an opposing side of the second piston; and
the first and second hydraulic directional control valves are operable out of phase with respect to each other such that the volumes of fluid discharged by each of the first and second chambers are introduced into the hydraulic actuator out of phase with respect to each other.

12. The apparatus of claim 10 further comprising a controller comprising a processor and a memory storing computer program code, wherein the controller is operable to:
receive, from a position sensor disposed in association with the fluid chamber, a signal indicative of position of the piston within the fluid chamber;
operate the hydraulic directional control valve based on the received signal to direct the fluid from the fluid source into one of the first and second ports of the fluid chamber;
control the hydraulic directional control valve based on the received signal to substantially continuously direct the fluid from the fluid source alternatingly into one of the first and second ports of the fluid chamber to cause volumes of fluid to be substantially continuously discharged alternatingly out of the other of the first and second ports of the fluid chamber and into the hydraulic actuator to substantially continuously actuate the hydraulic actuator by distances corresponding to the volumes of the fluid received by the hydraulic actuator;
store information related to a predetermined number of strokes of the piston to be performed to achieve a predetermined movement of the hydraulic actuator;
record the number the strokes performed by the piston based on the signal generated by the position sensor; and
cause the hydraulic directional control valve to stop directing fluid to the chamber when the recorded number of strokes performed by the piston is equal to the predetermined number of strokes.

13. A method comprising:
directing a fluid from a fluid source into a first chamber portion of a fluid chamber until a piston dividing the fluid chamber into the first chamber portion and a second chamber portion moves from a first end of the fluid chamber to a second end of the fluid chamber to:
introduce a first volume of fluid into the first chamber portion; and
discharge a second volume of fluid from the second chamber portion;
directing the second volume of fluid discharged from the second chamber portion into a hydraulic actuator to actuate the hydraulic actuator by a first distance corresponding to the second volume of fluid received by the hydraulic actuator;
directing the fluid from the fluid source into the second chamber portion until the piston moves from the second end of the fluid chamber to the first end of the fluid chamber to:
introduce a third volume of fluid into the second chamber portion; and
discharge the first volume of fluid from the first chamber portion; and
directing the first volume of fluid discharged from the first chamber portion into the hydraulic actuator to actuate the hydraulic actuator by a second distance corresponding to the first volume of fluid received by the hydraulic actuator.

14. The method of claim 13 wherein:
the first volume of fluid is substantially equal to an internal volume of the first chamber portion;
the second and third volumes of fluid are substantially equal to an internal volume of the second chamber portion; and
the first and second distances are substantially equal.

15. The method of claim 13 wherein the hydraulic actuator is or comprises at least one of:
a hydraulic rotary actuator; and/or
a hydraulic cylinder.

16. The method of claim 13 further comprising:
directing the first and second volumes of fluid discharged from the first and second chamber portions into a first port of the hydraulic actuator to actuate the hydraulic actuator in a first direction; and
directing the first and second volumes of fluid discharged from the first and second chamber portions into a second port of the hydraulic actuator to actuate the hydraulic actuator in a second direction.

17. The method of claim 13 wherein the fluid chamber comprises a position sensor in signal communication with a controller comprising a processor and a memory storing computer program code, and wherein the method further comprises:
generating a signal with the position sensor indicative of position of the piston within the fluid chamber;
receiving the signal by the controller; and
operating with the controller a hydraulic directional control valve based on the signal to direct the fluid from the fluid source into one of the first and second chamber portions.

18. The method of claim 17 further comprising operating the hydraulic directional control valve to:
direct the fluid from the fluid source alternatingly into one of the first and second chamber portions to cause volumes of fluid to be substantially continuously discharged alternatingly out of the other of the first and second chamber portions; and
direct the volumes of fluid discharged from the first and second chamber portions into the hydraulic actuator to substantially continuously actuate the hydraulic actuator by incremental distances corresponding to the volumes of the fluid received by the hydraulic actuator.

19. The method of claim 13 wherein the fluid chamber is a first fluid chamber, wherein the hydraulic actuator is fluidly connected with the first fluid chamber and a second fluid chamber, and wherein the method further comprises operating the first and second fluid chambers out of phase with respect to each other such that the volumes of fluid discharged by each of the first and second fluid chambers are introduced into the hydraulic actuator out of phase with respect to each other.

20. The method of claim 13 wherein the hydraulic actuator and the fluid chamber form at least a portion of a pipe moving device utilized on an oilfield drill rig, and wherein the method further comprises directing the fluid from the fluid source alternatingly into one of the first and second chamber portions to cause volumes of fluid to be substantially continuously discharged alternatingly out of the other of the first and second chamber portions into the hydraulic actuator to substantially continuously actuate the hydraulic actuator until the pipe moving device moves a drill pipe from a first position to a second position.
